(19) United States
(12) Patent Application Publication
(10) Pub. No.: US 2018/0361404 A1
(43) Pub. Date: Dec. 20, 2018

(54) Air Blowing Gun with Pressure-Relief Function

(71) Applicant: Kuo-Chin Chiang, Taichung City (TW)

(72) Inventor: Kuo-Chin Chiang, Taichung City (TW)

(21) Appl. No.: 15/622,116

(22) Filed: Jun. 14, 2017

(51) Int. Cl. B05B 1/34; B05B 9/08

(52) U.S. Cl. CPC B05B 1/34; B05B 9/0805

(57) ABSTRACT

An air blowing gun includes an air outlet pipe, a connector mounted on the air outlet pipe, a body mounted on the air outlet pipe and connected with the connector, a nozzle mounted on a front end of the body, and a pressure-relief ring mounted on the body. The air outlet pipe has a front end provided with an air outlet port. The connector has a through hole mounted on the air outlet pipe. The body has an axial hole. The body has a plurality of pressure release holes corresponding to the air outlet port of the air outlet pipe and the pressure-relief ring. The nozzle has an air outlet hole. The pressure-relief ring has a plurality of elastic deformation portions corresponding to the body.

### BACKGROUND OF THE INVENTION

### 1. Field of the Invention

The present invention relates to a blowing tool and, more particularly, to an air blowing gun.

### 2. Description of the Related Art

A conventional air blowing gun comprises an air compressor producing a compressed air that is directly injected outward from a nozzle. Thus, the air blowing gun is used to perform a cleaning work. For example, the air blowing gun is used to blow and collect leaves, dust or impurities, or to clear cut chips or cutting liquid. However, the compressed air injected from the nozzle is concentrated and has a high speed, so that the user is easily damaged or hurt by the strong compressed air with a high pressure.

Another conventional air blowing gun with a flow regulating function comprises a blowing pipe having an air blowing port provided with a reduced neck, and two opposite side holes provided between the air blowing port and the reduced neck. Thus, when the compressed air passes through the reduced neck, the flow speed is increased to produce a vacuum state, and the two side holes suck the air, so that the flow rate at the air blowing port of the blowing pipe is increased. However, when the air is sucked into the two side holes, the sucking action produces disturbing noise, thereby providing an uncomfortable sensation to the user.

### BRIEF SUMMARY OF THE INVENTION

The primary objective of the present invention is to provide an air blowing gun with pressure-relief function.

In accordance with the present invention, there is provided an air blowing gun comprising an air outlet pipe, a connector mounted on the air outlet pipe, a body mounted on the air outlet pipe and connected with the connector, a nozzle mounted on a front end of the body, and a pressure-relief ring mounted on the body. The air outlet pipe has a front end provided with an air outlet port. The connector has a central position provided with a through hole mounted on the air outlet pipe. The body has a central position provided with an axial hole. The axial hole of the body has a diameter greater than the outer diameter of the air outlet port of the air outlet pipe. The body has a middle portion provided with a plurality of pressure release holes corresponding to the air outlet port of the air outlet pipe and the pressure-relief ring. The body has a periphery provided with a stepped portion located in front of the pressure release holes. The nozzle has a central position provided with an air outlet hole. The air outlet hole of the nozzle has a diameter smaller than that of the axial hole of the body. The pressure-relief ring has a front end provided with a connecting portion secured on the stepped portion of the body.

According to the primary advantage of the present invention, the pressure-relief ring provides a pressure-relief function to release the high pressure of the compressed air when the air flow from the nozzle is hindered by an obstruction, thereby preventing the user from being hurt by the strong air flow with a high pressure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective cross-sectional view of an air blowing gun in accordance with the preferred embodiment of the present invention.

FIG. 2 is an exploded perspective view of the air blowing gun in accordance with the preferred embodiment of the present invention.

FIG. 3 is a front cross-sectional view of the air blowing gun in accordance with the preferred embodiment of the present invention.

FIG. 4 is a cross-sectional view of the air blowing gun taken along line F-F as shown in FIG. 3.

FIG. 5 is a schematic operational view of the air blowing gun as shown in FIG. 4 in use.

### DETAILED DESCRIPTION OF THE INVENTION

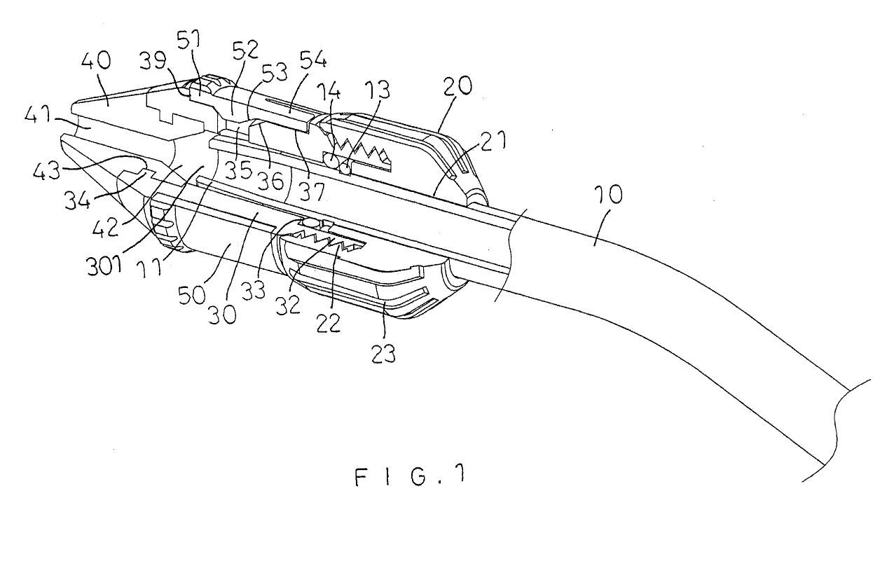

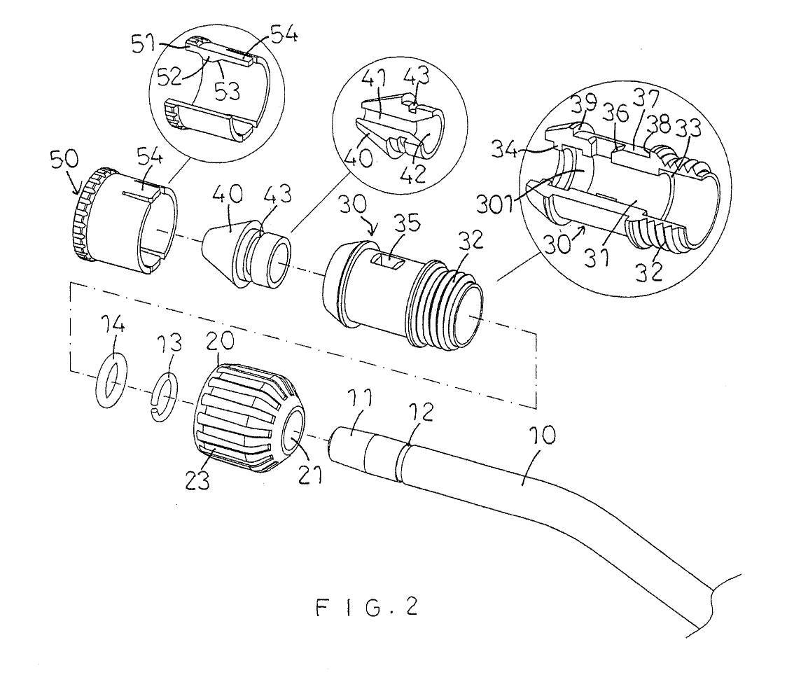

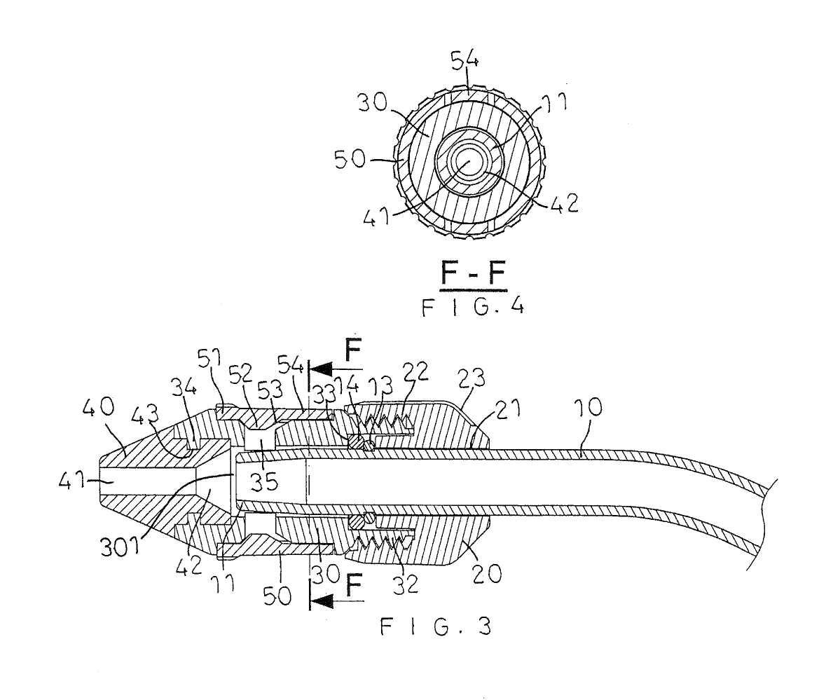

Referring to the drawings and initially to FIGS. 1-4, an air blowing gun in accordance with the preferred embodiment of the present invention comprises an air outlet pipe 10, a connector 20 mounted on the air outlet pipe 10, a body 30 mounted on the air outlet pipe 10 and connected with the connector 20, a nozzle 40 mounted on a front end of the body 30, and a pressure-relief ring 50 mounted on the body 30.

The air outlet pipe 10 has a front end provided with an air outlet port 11.

The connector 20 has a central position provided with a through hole 21 mounted on the air outlet pipe 10, and the air outlet port 11 of the air outlet pipe 10 protrudes outward from the through hole 21 of the connector 20. The through hole 21 of the connector 20 has a diameter equal to the outer diameter of the air outlet port 11 of the air outlet pipe 10.

The body 30 has a central position provided with an axial hole 31. The axial hole 31 of the body 30 has a diameter greater than the outer diameter of the air outlet port 11 of the air outlet pipe 10. The body 30 has a middle portion provided with a plurality of pressure release holes 35 corresponding to the air outlet port 11 of the air outlet pipe 10 and the pressure-relief ring 50. The body 30 has a periphery provided with a stepped portion 39 located in front of the pressure release holes 35. The body 30 is provided with a cavity 301 surrounding the air outlet port 11 of the air outlet pipe 10.

The nozzle 40 has a central position provided with an air outlet hole 41. The air outlet hole 41 of the nozzle 40 has a diameter smaller than that of the axial hole 31 of the body 30.

The pressure-relief ring 50 has a front end provided with a connecting portion 51 secured on the stepped portion 39 of the body 30. Preferably, the pressure-relief ring 50 is made of rubber or silica gel.

In the preferred embodiment of the present invention, the air outlet port 11 of the air outlet pipe 10 is gradually tapered inward.

In the preferred embodiment of the present invention, the air outlet hole 41 of the nozzle 40 has a rear end provided with a flow guide face 42 corresponding to the axial hole 31 of the body 30. The flow guide face 42 of the nozzle 40 has a conical shape with a narrow front portion and a wide rear portion.

In the preferred embodiment of the present invention, the air outlet pipe 10 has a periphery provided with a retaining groove 12, and a substantially C-shaped snap ring 13 is mounted in the retaining groove 12 of the air outlet pipe 10 and abuts a front end of the connector 20. In the preferred embodiment of the present invention, an O-ring 14 is mounted on the air outlet pipe 10 and is pressed between the air outlet pipe 10 and the body 30. The axial hole 31 of the body 30 is provided with a receiving recess 33 receiving the O-ring 14, and the O-ring 14 is closely fitted in a wall of the receiving recess 33 of the body 30. The snap ring 13 is also received in the receiving recess 33 of the body 30. In practice, an air compressor is connected to the air outlet pipe 10 by an external pipe to supply compressed air into the air outlet pipe 10. Thus, the O-ring 14 prevents the compressed air from leaking from the gap defined between the air outlet pipe 10 and the body 30.

In the preferred embodiment of the present invention, the body 30 is provided with an external thread 32, and the connector 20 is provided with an internal thread 22 screwed onto the external thread 32 of the body 30. The connector 20 has a periphery provided with a plurality of elongate slots 23 to facilitate the user holding the connector 20.

In the preferred embodiment of the present invention, the nozzle 40 is made of metallic material and has a conical shape with a narrow front portion and a wide rear portion.

In the preferred embodiment of the present invention, the periphery of the body 30 is provided with an oblique face 36 located in rear of the pressure release holes 35, a straight face 37 located in rear of the oblique face 36 and a vertical face 38 located in rear of the straight face 37. The pressure-relief ring 50 has an interior provided with a projection 52 corresponding to the pressure release holes 35 of the body 30. The projection 52 of the pressure-relief ring 50 is provided with an inclined face 53 corresponding to the oblique face 36 of the body 30. The pressure-relief ring 50 has a periphery provided with a plurality of elastic deformation portions 54 corresponding to the straight face 37 and the vertical face 38 of the body 30.

In the preferred embodiment of the present invention, the periphery of the nozzle 40 is provided with an annular groove 43, and the interior of the body 30 is provided with an annular flange 34 mounted in the annular groove 43 of the nozzle 40.

In operation, when the compressed air from the air compressor is delivered through the air outlet port 11 of the air outlet pipe 10 and injected into the nozzle 40, the air in the cavity 301 of the body 30 is sucked and carried away due to a siphoning action, so that the elastic deformation portions 54 of the pressure-relief ring 50 are drawn inward and locked. Thus, a siphon locking state is formed between the elastic deformation portions 54, the straight face 37 and the vertical face 38 under a normal condition, so that the body 30 and the pressure-relief ring 50 are locked at the normal state.

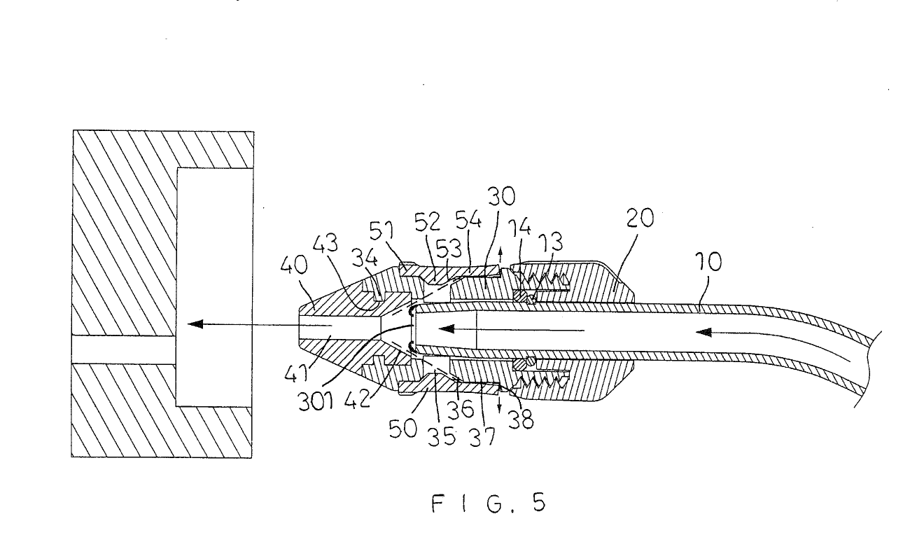

Referring to FIG. 5 with reference to FIGS. 1-3, when the air flow ejected from the nozzle 40 is hindered by a solid article, the air outlet speed is reduced, and a pressure is produced in the cavity 301 of the body 30. At this time, the elastic deformation portions 54 of the pressure-relief ring 50 are pushed and expanded outward to provide an air drain effect and to perform a pressure release action, so that the compressed air in the cavity 301 of the body 30 is delivered through the flow guide face 42 of the nozzle 40, the pressure release holes 35 of the body 30 and the inclined face 53 of the pressure-relief ring 50, and is drained outward from the elastic deformation portions 54 of the pressure-relief ring 50.

Accordingly, the pressure-relief ring 50 provides a pressure-relief function to release the high pressure of the compressed air when the air flow from the nozzle 40 is hindered by an obstruction, thereby preventing the user from being hurt by the strong air flow with a high pressure. In addition, the air blowing gun provides a silent pressure-relief device without producing noise, thereby providing a comfortable sensation to the user when operating the air blowing gun.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An air blowing gun comprising:
an air outlet pipe;
a connector mounted on the air outlet pipe;
a body mounted on the air outlet pipe and connected with the connector;
a nozzle mounted on a front end of the body; and
a pressure-relief ring mounted on the body;
wherein:
the air outlet pipe has a front end provided with an air outlet port;
the connector has a central position provided with a through hole mounted on the air outlet pipe;
the body has a central position provided with an axial hole;
the axial hole of the body has a diameter greater than the outer diameter of the air outlet port of the air outlet pipe;
the body has a middle portion provided with a plurality of pressure release holes corresponding to the air outlet port of the air outlet pipe and the pressure-relief ring;
the body has a periphery provided with a stepped portion located in front of the pressure release holes;
the nozzle has a central position provided with an air outlet hole;
the air outlet hole of the nozzle has a diameter smaller than that of the axial hole of the body; and
the pressure-relief ring has a front end provided with a connecting portion secured on the stepped portion of the body.

2. The air blowing gun of claim 1, wherein the air outlet port of the air outlet pipe is gradually tapered inward.

3. The air blowing gun of claim 1, wherein the air outlet hole of the nozzle has a rear end provided with a flow guide face corresponding to the axial hole of the body, and the flow guide face of the nozzle has a conical shape with a narrow front portion and a wide rear portion.

4. The air blowing gun of claim 1, wherein the air outlet pipe has a periphery provided with a retaining groove, and a substantially C-shaped snap ring is mounted in the retaining groove of the air outlet pipe and abuts a front end of the connector.

5. The air blowing gun of claim 1, wherein an O-ring is mounted on the air outlet pipe and is pressed between the air outlet pipe and the body, the axial hole of the body is provided with a receiving recess receiving the O-ring, and the O-ring is closely fitted in a wall of the receiving recess of the body.

6. The air blowing gun of claim 1, wherein:
the body is provided with an external thread;
the connector is provided with an internal thread screwed onto the external thread of the body; and
the connector has a periphery provided with a plurality of elongate slots.

7. The air blowing gun of claim 1, wherein the nozzle is made of metallic material and has a conical shape with a narrow front portion and a wide rear portion.

8. The air blowing gun of claim 1, wherein:
the body is provided with a cavity surrounding the air outlet port of the air outlet pipe;
the periphery of the body is provided with an oblique face located in rear of the pressure release holes, a straight face located in rear of the oblique face and a vertical face located in rear of the straight face;
the pressure-relief ring has an interior provided with a projection corresponding to the pressure release holes of the body;
the projection of the pressure-relief ring is provided with an inclined face corresponding to the oblique face of the body;
the pressure-relief ring has a periphery provided with a plurality of elastic deformation portions corresponding to the straight face and the vertical face of the body;
a siphon locking state is formed between the elastic deformation portions, the straight face and the vertical face under a normal condition; and
when an air flow ejected from the nozzle is hindered, a pressure is produced in the cavity of the body, and the elastic deformation portions of the pressure-relief ring are pressed outward to provide an air drain effect, so that the compressed air in the cavity of the body is delivered through the flow guide face of the nozzle, the pressure release holes of the body and the inclined face of the pressure-relief ring, and is drained outward from the elastic deformation portions of the pressure-relief ring.

9. The air blowing gun of claim 1, wherein the pressure-relief ring is made of rubber or silica gel.
